(19) United States
(12) Patent Application Publication
(10) Pub. No.: US 2024/0073873 A1
(43) Pub. Date: Feb. 29, 2024

(54) Multi-Slot Transmission of Transport Block

(71) Applicant: Apple Inc., Cupertino, CA (US)

(72) Inventors: Chunhai YAO, Beijing (CN); Dawei ZHANG, Saratoga, CA (US); Haitong SUN, Saratoga, CA (US); Hong HE, San Jose, CA (US); Oghenekome OTERI, San Diego, CA (US); Huaning NIU, San Jose, CA (US); Seyed Ali Akbar FAKOORIAN, San Diego, CA (US); Wei ZENG, Saratoga, CA (US); Yushu ZHANG, Beijing (CN); Weidong YANG, San Diego, CA (US)

(21) Appl. No.: 18/261,317

(22) PCT Filed: May 26, 2021
(86) PCT No.: PCT/CN2021/096069

§ 371 Date: Jul. 13, 2023

(30) Foreign Application Priority Data
Jan. 15, 2021 (WO) PCT/CN2021/072077

(51) Int. Cl. H04W 72/0446

(52) U.S. Cl. CPC H04W 72/0446

(57) ABSTRACT

Example embodiments of the present disclosure relate to methods, devices, apparatuses and computer readable storage media for multi-slot transmission of a transport block (TB). In example embodiments, a user device determines a transport block size (TBS) based on a plurality of slots. The user device transmits a TB with the TBS over the plurality of slots.

### FIELD

Example embodiments of the present disclosure generally relate to the field of communications, and in particular, to methods, apparatuses and computer readable storage media for multi-slot transmission of a transport block (TB).

### BACKGROUND

New Radio (NR) coverage enhancement has been approved in the fifth generation (5G). Some of the objectives are proposed for NR coverage enhancement. For example, the performance target for coverage enhancement is identified, and the potential solutions for coverage enhancements are studied. The target channels include at least Physical Uplink Shared Channel (PUSCH) and Physical Uplink Control Channel (PUCCH). Enhanced solutions may include time domain and frequency domain enhancement, Demodulation-Reference Signal (DM-RS) enhancement (including DM-RS-less transmission). The additional enhanced solutions may also be developed for Frequency Range 2 (FR2) if any. The performance of the potential solutions may be evaluated based on link level simulation.

Some agreements for NR coverage enhancement are proposed to be specified in the 3GPP standards such as 3GPP TR 38.830. For example, Transport Block (TB) processing over multi-slot PUSCH may be used for transmission/reception (TR). TB processing over multi-slot may have impacts on PUSCH in the terms of Time-Domain Resource Allocation (TDRA), Transport Block Size (TBS) determination, and Redundancy Version (RV) determination. Power consistency, phase continuity and enhancements for DM-RS configuration may or may not be required depending on factors such as cross-slot channel estimation.

### SUMMARY

In general, example embodiments of the present disclosure provide methods, devices and computer readable storage medium for multi-slot transmission of a transport block (TB).

In a first aspect, a method is provided. In the method, a user device determines a TBS based on a plurality of slots. With the TBS, the user device transmits a TB over the plurality of slots.

In a second aspect, a user device is provided which comprises at least one processor and at least one memory including computer program code. The at least one memory and the computer program code are configured to, with the at least one processor, cause the user device to determine a TBS based on a plurality of slots. The user device is further caused to transmit a TB over the plurality of slots with the TBS.

In a third aspect, there is provided an apparatus comprising means for performing the method according to the first aspect.

In a fourth aspect, there is provided a computer readable storage medium comprising program instructions stored thereon. The instructions, when executed by a processor of a user device, cause the user device to perform the method according to the first aspect.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, where:

FIG. 1 shows a simplified block diagram of an environment in which embodiments of the present disclosure may be implemented;

FIG. 2 shows a flowchart of an example method for transmitting TBs according to some example embodiments of the present disclosure;

FIG. 3A shows an example mapping order for transmitting TBs according to some example embodiments of the present disclosure;

FIG. 3B shows another example mapping order for transmitting TBs according to some example embodiments of the present disclosure; and

FIG. 4 illustrates a simplified block diagram of a device that is suitable for implementing example embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these example embodiments are described only for the purpose of illustration and help those skilled in the art to understand and implement the present disclosure, without suggesting any limitation as to the scope of the disclosure. The disclosure described herein may be implemented in various manners other than the ones described below.

In the following description and claims, unless defined otherwise, all technical and scientific terms used herein have the same meaning as commonly understood by one of ordinary skills in the art to which this disclosure belongs.

As used herein, the term “network device” refers to a device via which services may be provided to a user device in a communication network. As an example, the network device may comprise a base station. As used herein, the term “base station” (BS) refers to a network device via which services may be provided to a user device in a communication network. The base station may comprise any suitable device via which a user device or UE may access the communication network. Examples of the base stations include a relay, an access point (AP), a transmission point (TRP), a node B (NodeB or NB), an evolved NodeB (eNodeB or eNB), a New Radio (NR) NodeB (gNB), a Remote Radio Module (RRU), a radio header (RH), a remote radio head (RRH), a low power node such as a femto, a pico, and the like.

As used herein, the term “user device” or “user equipment” (UE) refers to any user device capable of wireless communications with each other or with the base station. The communications may involve transmitting and/or receiving wireless signals using electromagnetic signals, radio waves, infrared signals, and/or other types of signals suitable for conveying information over air. In some example embodiments, the UE may be configured to transmit and/or receive information without direct human interaction. For example, the UE may transmit information to the base station on predetermined schedules, when triggered by an internal or external event, or in response to requests from the network side.

Examples of the user device include, but are not limited to, user device (UE) such as smart phones, wireless-enabled tablet computers, laptop-embedded equipment (LEE), laptop-mounted equipment (LME), and/or wireless customer-premises equipment (CPE). For the purpose of discussion, in the following, some embodiments will be described with reference to UEs as examples of the user devices, and the terms “terminal device” and “user device” (UE) may be used interchangeably in the context of the present disclosure.

As used herein, the singular forms “a”, “an”, and “the” are intended to include the plural forms as well, unless the context clearly indicates otherwise. The term “includes” and its variants are to be read as open terms that mean “includes, but is not limited to”. The term “based on” is to be read as “based at least in part on”. The term “one embodiment” and “an embodiment” are to be read as “at least one embodiment”. The term “another embodiment” is to be read as “at least one other embodiment”. Other definitions, explicit and implicit, may be included below.

Traditionally, one TB is transmitted on a single slot, and multiple physical resource blocks (PRBs) are applied. In addition, time domain repetition is applied widely, in which a full TB is repeated in a time domain. For the purpose of power boosting gain and lower coding rate, a multi-slot transmission scheme is provided.

For NR coverage enhancement, one of the objectives is to specify mechanism(s) to support TB processing over multi-slot PUSCH. Comparing with single-slot transmission with same target data rate, TB processing over multi-slot could provide the power boosting gain. Modulated symbols may be mapped over multiple resources in the time domain to ensure a higher spectral density. In addition, comparing with the time domain repetition, it could get the benefits of lower coding rate and less-CRC padding for small data packet

In the multi-slot transmission scheme, one TB could be transmitted over a plurality of slots and thus one issue may be the determination of TBS by UE and the same assumption should be applied to the network device. Moreover, the appropriate transmission scheme over a plurality of slots is needed.

Embodiments of the present disclosure provide the solutions of TBS determination for different TB processing schemes. The user device firstly determines a TBS based on a plurality of slots. Further, for the purpose of improving transmission performance, some processing schemes for TB transmission are provided. For example, a TB with the TBS may be segmented into a plurality of smaller data packets and then the plurality of smaller data packets are transmitted over the plurality of slots. As such, a TB may be transmitted over a plurality of slots effectively or efficiently.

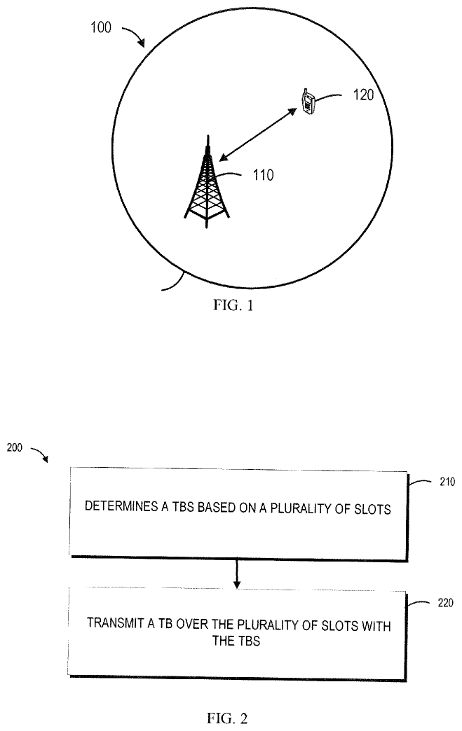

FIG. 1 shows a block diagram of an environment in which embodiments of the present disclosure may be implemented. The environment 100, which is a part of a communication network, includes a network device 110 and a user device 120 communicating with each other in a serving area of the network device 120 which is called as a cell 102.

It is to be understood that two devices are shown in the environment 100 only for the purpose of illustration, without suggesting any limitation to the scope of the present disclosure. In some example embodiments, the environment 100 may comprise a further device to communicate information with the network device 110 and user device 120. The communications in the environment 100 may follow any suitable communication standards or protocols, which are already in existence or to be developed in the future, such as Universal Mobile Telecommunications System (UMTS), long term evolution (LTE), LTE-Advanced (LTE-A), the fifth generation (5G) New Radio (NR), Wireless Fidelity (Wi-Fi) and Worldwide Interoperability for Microwave Access (WiMAX) standards, and employs any suitable communication technologies, including, for example, Multiple-Input Multiple-Output (MIMO), Orthogonal Frequency Division Multiplexing (OFDM), time division multiplexing (TDM), frequency division multiplexing (FDM), code division multiplexing (CDM), Bluetooth, ZigBee, and machine type communication (MTC), enhanced mobile broadband (eMBB), massive machine type communication (mMTC), ultra-reliable low latency communication (URLLC), Carrier Aggregation (CA), Dual Connection (DC), and New Radio Unlicensed (NR-U) technologies.

In various embodiments, the user device 120 determines a TBS based on a plurality of slots and then transmits a TB with the TBS over these slots.

FIG. 2 shows a flowchart of an example method 200 for transmitting TBs according to some example embodiments of the present disclosure. The method 200 may be implemented by the user device 120 as shown in FIG. 1. For the purpose of discussion, the method 200 will be described with reference to FIG. 1.

At block 210, the user device 120 determines a TBS based on a plurality of slots. In some embodiments, the user device 120 may determine a total number of available resource elements (REs) in the plurality of slots, determine, based on the total number of available REs, the number of allowed information bits in the plurality of slots; and determine the TBS based on the number of allowed information bits.

In some embodiments, to determine the total number of available REs in the plurality of slots, the user device 120 may determine the number of available REs for each slot of the plurality of slots; and determine the total number of available REs as a sum of available REs determined for the plurality of slots.

In some embodiments, to determine the total number of available REs on the plurality of slots, the user device 120 may determine a reference number of available REs for a reference slot of the plurality of slots; and determine the total number of available REs as a product of the reference number of available REs and the number of slots of the plurality of slots.

For example, the TBS may be determined in the following manner. First, a total number of available resource elements (REs) in the plurality of slots. To this end, a reference number of REs in a slot, noted as N_{RE}^{slot}′, may be determined as Equation (1):

N_{RE}^{slot}′=N_{SC}^{RB}N_{symbol}^{sh}−N_{DMRS}^{PRB}−Nₒₕ^{PRB} (1)

where N_{symbol}^{sh} represents the number of symbols of Physical Uplink Shared Channel (PUSCH) allocation within the slot, N_{SC}^{RB} represents the number of subcarriers in a PRB and equals to 12, N_{DMRS}^{PRB} represents the number of the resource elements (REs) for DM-RS, and Nₒₕ^{PRB} represents the number of the REs for overhead configured by Radio Resource Control (RRC) signaling.

In some embodiments, the number of available REs for each slot of the plurality of slots, noted as N_{RE}^{slot}, may be determined as Equation (2):

N_{RE}^{slot}=min(DI,N_{RE}^{slot}′)n_{PRB} (2)

where n_{PRB} is the allocated PRB for the UE, DI represents the difference between the number of all REs and the number of REs used for Demodulation Reference Signal (DMRS). For example, in some implementations, the number of all RE may be 168, and the number of REs used for DMRS may be 12. In this situation, DI is 156. It is to be understood that this example is merely for the purpose of illustration, without suggesting any limitations as to the scope of the present disclosure.

Alternatively, in some other embodiments, N_{RE}^{slot} may be determined as N_{RE}^{slot}′n_{PRB} if no DMRS may be configured in specific slot.

Then, in some embodiments, the total number of available REs in the plurality of slots, noted as N_{RE}, may be calculated as Equation (3):

N_{RE}=N_{RE}^{slot1}+N_{RE}^{slot2}+N_{RE}^{slot3} . . . +N_{RE}^{slotn} (3)

where N_{RE}^{slot1}, N_{RE}^{slot2}, . . . , N_{RE}^{slotn} represent the numbers of available REs determined for the plurality of slots.

In these embodiments, it is assumed that different slots have different RE allocations. Thus, the total number of available REs may be determined as a sum of a plurality of numbers of available REs determined for the plurality of slots.

Alternatively, in some other embodiments, N_{RE} may be calculated as Equation (4):

N_{RE}=Nₛₗₒₜ*N_{RE}^{slot} (4)

where N_{RE}^{slot} represents the reference number of available REs, and Nₛₗₒₜ represents the number of slots of the plurality of slots.

In these embodiments, it is assumed that different slots have the same RE allocation. Thus, the total number of available REs may be determined as a product of the reference number of available REs and the number of slots of the plurality of slots.

Next, the number of allowed information bits in the plurality of slots, noted as N_{info}, may be determined as Equation (5):

N_{info}=N_{RE}*R*Qₘ*v (5)

where R represents coding rate, Qₘ represents the modulation order, v represents the MIMO layer.

Further, based on the number of allowed information bits, the TBS may be determined using the defined TBS table in the specification.

At block 220, the user device 120 transmits a TB to the network device 110 over the plurality of slots with the TBS as determined at block 210.

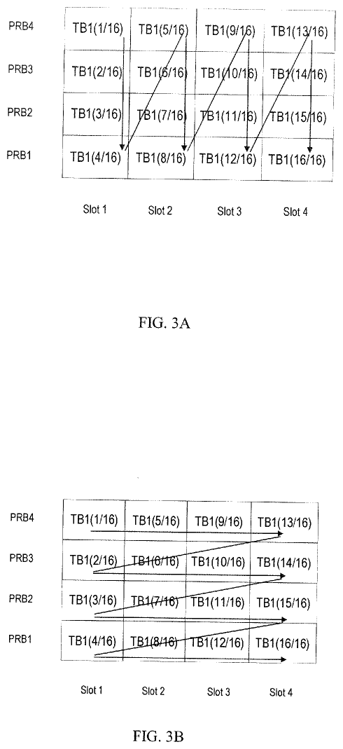

The user device 120 may generate a plurality of coded bits from the TB. Before mapping the plurality of coded bits to a physical layer resource, the user device 120 may group plurality of coded bits into a plurality of TB trunks according to the number of slots and PRBs to be used. Then the plurality of TB trunks may be mapped on RE based on specific mapping order. For example, the user device 120 may map the plurality of TB trunks onto a plurality of PRBs over the plurality of slots on the basis of bands, PRBs or slots. Example mapping orders will be discussed below with reference to FIGS. 3A and 3B.

FIG. 3A shows an example mapping order for the TB transmission according to some example embodiments of the present disclosure.

As shown in FIG. 3A, there may be 4 slots and 4 PRBs. In this example, the plurality of coded bits are grouped into 16 TB trunks. According to the available REs in the slot, the size of TB trunks may be different in different slots. It is to be understood that this example is merely for the purpose of illustration, without suggesting any limitations as to the scope of the present disclosure. As shown in FIG. 3A, the TB trunks may be mapped in the order “frequency first, time domain second” as shown by arrow. As such, the mapping may be on the basis of slots.

FIG. 3B shows another example mapping order for the TB transmission according to some example embodiments of the present disclosure.

As shown in FIG. 3B, the TB trunks may be mapped in the order “time domain first, frequency domain second”. As such, the mapping may be on the basis of PRBs.

In some embodiments, the user device 120 may generate a plurality of cyclic redundancy check (CRC) bits from the TB. A plurality of coded bits are generated from the TB based on the plurality of CRC bits. The plurality of coded bits may be divided into a plurality of segments of coded bits, and a segment of coded bits of the plurality of segments of coded bits may be transmitted in a slot of the plurality of slots. In these embodiments, only one CRC is attached on one TB, thus transmission in each slot is non self-decodable, which means that if the TB is not decoded correctly, the whole TB will be re-transmitted within configured slots.

In some embodiments, the user device 120 may transmit the TB using a redundancy version over the plurality of slots. Thus, the transmitted TB is enabled to be individually decoded. In some embodiments, the user device 120 may retransmit the TB over the plurality of slots using a different redundancy version. Thus the retransmitted TB is enabled to be decoded. According to network configuration, the redundancy version pattern may be set to {0,2,3,1} or {0,3}, for example.

In some embodiments, the TB transmission may be performed based on code block groups (CBG). The user device 120 may determine a code block (CB) size. For LDPC code block segmentation, the maximum code block size, noted as Kcb, is 8848 bits for base graph 1 and 3840 for base graph 2. If the TBS is larger than Kcb, the TB will be divided into a plurality of CBs with the CB size and the plurality of CBs will be transmitted over the plurality of slots. Each CB will independently perform CRC attaching, LDPC coding, and HARQ.

The CB size may be determined for TB processing over multi-slot in any suitable way. In some embodiments, the CB size may be configured by the network device 110. For example, network device 110 may configure CB sizes for base graph 1 and base graph 2. Alternatively, in other embodiments, the CB size may be configured to a fixed value in the specification for multi-slot transmission. In yet other embodiments, the CB size may be selected from a set of CB sizes based on at least one of the TBS, the number of slots of the plurality of slots and coding rate. The number of slots may determine the number of CBG. If the number of CBs is larger than the number of CBGs, then CBs are grouped in one CBG

CBG based transmission may improve TB over multi-slot transmission efficiency, for the reason that if one of CBs in the TB is not decoded correctly, then only this CBG will be re-transmitted, and the whole TB will not be re-transmitted. In some embodiments, if the user device 120 in the cell edge, the data rate is lower and normally the TBS is less than 3840 bit, and thus in this situation, CBG based transmission may be applied.

In some embodiments, the user device 120 determines the number of CBG firstly. Then based on the number of CBG, the plurality of CBs may be grouped into a plurality of CBG. The user device 120 transmits the plurality of CBG to the network device 110 over the plurality of slots.

To determine the number of CBG, the reference number of CBG, noted as N, may be determined. The number of CBG for the TB, noted as M, may be determined as Equation (6):

M=min(N,C) (6)

where C represents the number of CBs for the TB. In such embodiments, the number of CBG for the TB may be determined as a smaller number of the reference number of CBG and the number of CBs for the TB.

In some embodiments, the reference number of CBG may be the maximum number of CBG. In some other embodiments, the reference number of CBG may be indicated by a network device. Alternatively, in some other embodiments, the reference number of CBG may be the same as the number of slots of the plurality of slots. In some other embodiments, an indication of the number of CBG and the number of slots for retransmission of the TB may be received from the network device 110.

In some other embodiments, the user device 120 transmits the TB to the network device 110 in each of the plurality of slots using a different redundancy version. The redundancy version may be configured as {0,2,3,1} or {0,3}. This is mainly used for semi-persistent scheduling, SPS, transmission, the packet size for SPS is fixed, the TB is transmitted over multi-slot, each slot is self-decodable.

In other embodiments, for at least a slot of the plurality of slots, Based on Nₛₗₒₜ, the number of allocated PRBs, noted as n_{PRB}, may be modified by the user device 120 as Equation (7):

n_{PRB}=floor(N_{PRB}/Nₛₗₒₜ) (7)

where N_{PRB} represents the reference number of allocated PRBs and is assigned by Modulation Coding Scheme, MCS.

Thus, in thus embodiments, the total number of available REs in the plurality of slots may be determined, based on which, the number of allowed information bits in the plurality of slots may be determined.

Alternatively, in other embodiments, based on Based on Nₛₗₒₜ, the coding rate for the TB, noted as R, may be modified as Equation (8):

R=R_{target}/Nₛₗₒₜ (8)

where R_{target} represents the target coding rate. The nearest coding rate is selected to R from the MCS table. If the coding rate is smaller than lowest value to that Qₘ, then Qₘ−2 and R=R_{target}/(Nₛₗₒₜ/2). Further, the TBS may be determined based on the number of allowed information bits. Based on the total number of available REs and the modified coding rate, the number of allowed information bits in the plurality of slots may be determined. Thus the TBS may be determined.

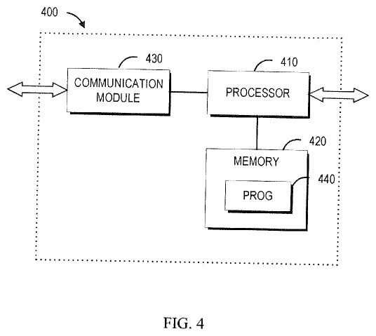

FIG. 4 is a simplified block diagram of a device 400 that is suitable for implementing example embodiments of the present disclosure. The device 400 may be implemented at or as a part of the network device 110 or the user device 120 as shown in FIG. 1.

As shown, the device 400 includes a processor 410, a memory 420 coupled to the processor 410, a communication module 430 coupled to the processor 410, and a communication interface (not shown) coupled to the communication module 430. The memory 420 stores at least a program 440. The communication module 430 is for bidirectional communications, for example, via multiple antennas. The communication interface may represent any interface that is necessary for communication.

The program 440 is assumed to include program instructions that, when executed by the associated processor 410, enable the device 400 to operate in accordance with the example embodiments of the present disclosure, as discussed herein with reference to FIGS. 1-3B. The example embodiments herein may be implemented by computer software executable by the processor 410 of the device 400, or by hardware, or by a combination of software and hardware. The processor 410 may be configured to implement various example embodiments of the present disclosure.

The memory 420 may be of any type suitable to the local technical network and may be implemented using any suitable data storage technology, such as a non-transitory computer readable storage medium, semiconductor based memory devices, magnetic memory devices and systems, optical memory devices and systems, fixed memory and removable memory, as non-limiting examples. While only one memory 420 is shown in the device 400, there may be several physically distinct memory modules in the device 400. The processor 410 may be of any type suitable to the local technical network, and may include one or more of general purpose computers, special purpose computers, microprocessors, digital signal processors (DSPs) and processors based on multicore processor architecture, as non-limiting examples. The device 400 may have multiple processors, such as an application specific integrated circuit chip that is slaved in time to a clock which synchronizes the main processor.

When the device 400 acts as the user device 120 or a part of the user device 120, the processor 410 and the communication module 430 may cooperate to implement the method 600 as described above with reference to FIGS. 1-3B. All operations and features as described above with reference to FIGS. 1-3B are likewise applicable to the device 400 and have similar effects. For the purpose of simplification, the details will be omitted.

Generally, various example embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of example embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the method 200 as described above with reference to FIG. 2. Generally, program modules include routines, programs, libraries, objects, classes, components, data structures, or the like that perform particular tasks or implement particular abstract data types. The functionality of the program modules may be combined or split between program modules as desired in various example embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program codes or related data may be carried by any suitable carrier to enable the device, apparatus or processor to perform various processes and operations as described above. Examples of the carrier include a signal, computer readable media.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), Digital Versatile Disc (DVD), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular example embodiments. Certain features that are described in the context of separate example embodiments may also be implemented in combination in a single embodiment. Conversely, various features that are described in the context of a single embodiment may also be implemented in multiple example embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

Various example embodiments of the techniques have been described. In addition to or as an alternative to the above, the following examples are described. The features described in any of the following examples may be utilized with any of the other examples described herein.

In some aspects, a method comprising: determining, at a user device, a transport block size, TBS, based on a plurality of slots; and transmitting, over the plurality of slots, a transport block, TB, with the TBS.

In some example embodiments, determining the TBS comprises: determining a total number of available resource elements, REs, in the plurality of slots; determining, based on the total number of available REs, the number of allowed information bits in the plurality of slots; and determining the TBS based on the number of allowed information bits.

In some example embodiments, determining the total number of available REs in the plurality of slots comprises: determining the number of available REs for each slot of the plurality of slots; and determining the total number of available REs as a sum of a plurality of numbers of available REs determined for the plurality of slots.

In some example embodiments, determining the total number of available REs on the plurality of slots comprises: determining a reference number of available REs for a reference slot of the plurality of slots; and determining the total number of available REs as a product of the reference number of available REs and the number of slots of the plurality of slots.

In some example embodiments, transmitting the TB comprises: generating a plurality of coded bits from the TB; grouping the plurality of coded bits into a plurality of TB trunks; and mapping the plurality of TB trunks onto a plurality of PRBs over the plurality of slots on the basis of PRBs or on the basis of slots.

In some example embodiments, transmitting the TB comprises: generating a plurality of cyclic redundancy check bits from the TB; generating a plurality of coded bits from the TB based on the plurality of cyclic redundancy check bits; dividing the plurality of coded bits into a plurality of segments of coded bits; and transmitting a segment of coded bits of the plurality of segments of coded bits in a slot of the plurality of slots.

In some example embodiments, transmitting the TB comprises: transmitting, over the plurality of slots, the TB using a redundancy version to enable the transmitted TB to be individually decoded.

In some example embodiments, the method further comprises: retransmitting the TB over the plurality of slots using a different redundancy version to enable the retransmitted TB to be decoded.

In some example embodiments, transmitting the TB comprises: determining a code block, CB, size; dividing the TB into a plurality of CBs with the CB size; and transmitting the plurality of CBs over the plurality of slots.

In some example embodiments, the CB size is: fixed value, configured by a network device, or selected from a set of CB sizes based on at least one of the TBS, the number of slots of the plurality of slots and coding rate.

In some example embodiments, transmitting the plurality of CBs over the plurality of slots comprises: determining the number of CB groups, CBG; grouping, based on the number of CBG, the plurality of CBs into a plurality of CBG; and transmitting the plurality of CBG over the plurality of slots.

In some example embodiments, determining the number of CBG comprises: determining a reference number CBG; determining the number of CBG for the TB as a smaller number of the reference number of CBG and the number of CBs for the TB.

In some example embodiments, the reference number CBG is indicated by a network device or the same as the number of slots of the plurality of slots.

In some example embodiments, the method further comprising: receiving, from a network device, an indication of the number of CBG and the number of slots for retransmission of the TB.

In some example embodiments, transmitting the TB comprises: transmitting the TB in each of the plurality of slots using a different redundancy version.

In some example embodiments, determining the TBS comprises: for at least a slot of the plurality of slots, modifying the number of allocated physical resource blocks, PRBs, based on the number of slots of the plurality of slots; determining the number of available resource elements, REs, based on the modified number of allocated PRBs; and determining a total number of available REs in the plurality of slots; determining, based on the total number of available REs, the number of allowed information bits in the plurality of slots; and determining the TBS based on the number of allowed information bits.

In some example embodiments, determining the number of allowed information bits in the plurality of slots comprises: modifying a coding rate for the TB based on the number of slots; and determining, based on the total number of available REs and the modified coding rate, the number of allowed information bits in the plurality of slots.

In some aspects, a user device, comprises: at least one processor; and at least one memory including computer program code; the at least one memory and the computer program code configured to, with the at least one processor, cause the user device to: determine, at a user device, a transport block size, TBS, based on a plurality of slots; and transmit, over the plurality of slots, a transport block, TB, with the TBS.

In some example embodiments, the at least one memory and the computer program code configured to, with the at least one processor, further cause the user device to: determine a total number of available resource elements, REs, in the plurality of slots; determine, based on the total number of available REs, the number of allowed information bits in the plurality of slots; and determine the TBS based on the number of allowed information bits.

In some example embodiments, the at least one memory and the computer program code configured to, with the at least one processor, further cause the user device to: determine the number of available REs for each slot of the plurality of slots; and determine the total number of available REs as a sum of a plurality of numbers of available REs determined for the plurality of slots.

In some example embodiments, the at least one memory and the computer program code configured to, with the at least one processor, further cause the user device to: determine a reference number of available REs for a reference slot of the plurality of slots; and determine the total number of available REs as a product of the reference number of available REs and the number of slots of the plurality of slots.

In some example embodiments, the at least one memory and the computer program code configured to, with the at least one processor, further cause the user device to: generate a plurality of coded bits from the TB; group the plurality of coded bits into a plurality of TB trunks; and map the plurality of TB trunks onto a plurality of PRBs over the plurality of slots on the basis of PRBs or on the basis of slots.

In some example embodiments, the at least one memory and the computer program code configured to, with the at least one processor, further cause the user device to: generate a plurality of cyclic redundancy check bits from the TB; generate a plurality of coded bits from the TB based on the plurality of cyclic redundancy check bits; divide the plurality of coded bits into a plurality of segments of coded bits; and transmit a segment of coded bits of the plurality of segments of coded bits in a slot of the plurality of slots.

In some example embodiments, the at least one memory and the computer program code configured to, with the at least one processor, further cause the user device to: transmit, over the plurality of slots, the TB using a redundancy version to enable the transmitted TB to be individually decoded.

In some example embodiments, the at least one memory and the computer program code configured to, with the at least one processor, further cause the user device to: retransmit the TB over the plurality of slots using a different redundancy version to enable the retransmitted TB to be decoded.

In some example embodiments, the at least one memory and the computer program code configured to, with the at least one processor, further cause the user device to: determine a code block, CB, size; divide the TB into a plurality of CBs with the CB size; and transmit the plurality of CBs over the plurality of slots.

In some example embodiments, the CB size is: a fixed value, configured by a network device, or selected from a set of CB sizes based on at least one of the TBS, the number of slots of the plurality of slots and coding rate.

In some example embodiments, the at least one memory and the computer program code configured to, with the at least one processor, further cause the user device to: determine the number of CB groups, CBG; group, based on the number of CBG, the plurality of CBs into a plurality of CBG; and transmit the plurality of CBG over the plurality of slots.

In some example embodiments, the at least one memory and the computer program code configured to, with the at least one processor, further cause the user device to: determine a reference number CBG; determine the number of CBG for the TB as a smaller number of the reference number of CBG and the number of CBs for the TB.

In some example embodiments, the reference number CBG is indicated by a network device or the same as the number of slots of the plurality of slots.

In some example embodiments, the at least one memory and the computer program code configured to, with the at least one processor, further cause the user device to: receive, from a network device, an indication of the number of CBG and the number of slots for retransmission of the TB.

In some example embodiments, the at least one memory and the computer program code configured to, with the at least one processor, further cause the user device to: transmit the TB in each of the plurality of slots using a different redundancy version.

In some example embodiments, the at least one memory and the computer program code configured to, with the at least one processor, further cause the user device to: for at least a slot of the plurality of slots, modify the number of allocated physical resource blocks, PRBs, based on the number of slots of the plurality of slots; determine the number of available resource elements, REs, based on the modified number of allocated PRBs; and determine a total number of available REs in the plurality of slots; determine, based on the total number of available REs, the number of allowed information bits in the plurality of slots; and determine the TBS based on the number of allowed information bits.

In some example embodiments, the at least one memory and the computer program code configured to, with the at least one processor, further cause the user device to: modify a coding rate for the TB based on the number of slots; and determine, based on the total number of available REs and the modified coding rate, the number of allowed information bits in the plurality of slots.

In some aspects, an apparatus comprises: means for determining, at a user device, a transport block size, TBS, based on a plurality of slots; and means for transmitting, over the plurality of slots, a transport block, TB, with the TBS.

In some example embodiments, the means for determining the TBS comprises: means for determining a total number of available resource elements, REs, in the plurality of slots; means for determining, based on the total number of available REs, the number of allowed information bits in the plurality of slots; and means for determining the TBS based on the number of allowed information bits.

In some example embodiments, the means for determining the total number of available REs in the plurality of slots comprises: means for determining the number of available REs for each slot of the plurality of slots; and means for determining the total number of available REs as a sum of a plurality of numbers of available REs determined for the plurality of slots.

In some example embodiments, the means for determining the total number of available REs on the plurality of slots comprises: means for determining a reference number of available REs for a reference slot of the plurality of slots; and means for determining the total number of available REs as a product of the reference number of available REs and the number of slots of the plurality of slots.

In some example embodiments, the means for transmitting the TB comprises: means for generating a plurality of coded bits from the TB; means for grouping the plurality of coded bits into a plurality of TB trunks; and means for mapping the plurality of TB trunks onto a plurality of PRBs over the plurality of slots on the basis of PRBs or on the basis of slots.

In some example embodiments, the means for transmitting the TB comprises: means for generating a plurality of cyclic redundancy check bits from the TB; means for generating a plurality of coded bits from the TB based on the plurality of cyclic redundancy check bits; means for dividing the plurality of coded bits into a plurality of segments of coded bits; and means for transmitting a segment of coded bits of the plurality of segments of coded bits in a slot of the plurality of slots.

In some example embodiments, the means for transmitting the TB comprises: means for transmitting, over the plurality of slots, the TB using a redundancy version to enable the transmitted TB to be individually decoded.

In some example embodiments, the apparatus further comprises: means for retransmitting the TB over the plurality of slots using a different redundancy version to enable the retransmitted TB to be decoded.

In some example embodiments, the means for transmitting the TB comprises: means for determining a code block, CB, size; means for dividing the TB into a plurality of CBs with the CB size; and means for transmitting the plurality of CBs over the plurality of slots.

In some example embodiments, the CB size is: a fixed value, configured by a network device, or selected from a set of CB sizes based on at least one of the TBS, the number of slots of the plurality of slots and coding rate.

In some example embodiments, the means for transmitting the plurality of CBs over the plurality of slots comprises: means for determining the number of CB groups, CBG; means for grouping, based on the number of CBG, the plurality of CBs into a plurality of CBG; and means for transmitting the plurality of CBG over the plurality of slots.

In some example embodiments, the means for determining the number of CBG comprises: means for determining a reference number CBG; means for determining the number of CBG for the TB as a smaller number of the reference number of CBG and the number of CBs for the TB.

In some example embodiments, the reference number CBG is indicated by a network device or the same as the number of slots of the plurality of slots.

In some example embodiments, the apparatus further comprises: means for receiving, from a network device, an indication of the number of CBG and the number of slots for retransmission of the TB.

In some example embodiments, the means for transmitting the TB comprises: means for transmitting the TB in each of the plurality of slots using a different redundancy version.

In some example embodiments, the means for determining the TBS comprises: means for, for at least a slot of the plurality of slots, modifying the number of allocated physical resource blocks, PRBs, based on the number of slots of the plurality of slots; means for, for at least a slot of the plurality of slots, determining the number of available resource elements, REs, based on the modified number of allocated PRBs; and means for determining a total number of available REs in the plurality of slots; means for determining, based on the total number of available REs, the number of allowed information bits in the plurality of slots; and means for determining the TBS based on the number of allowed information bits.

In some example embodiments, the means for determining the number of allowed information bits in the plurality of slots comprises: means for modifying a coding rate for the TB based on the number of slots; and means for determining, based on the total number of available REs and the modified coding rate, the number of allowed information bits in the plurality of slots.

In some aspects, a computer readable storage medium comprises program instructions stored thereon, the instructions, when executed by a processor of a user device, causing the user device to perform the method according to some example embodiments of the present disclosure.

In some aspects, a baseband processor of a user device is configured to perform the method according to some example embodiments of the present disclosure.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

1. A method comprising:
determining, at a user device, a transport block size, TBS, based on a plurality of slots; and
transmitting, over the plurality of slots, a transport block, TB, with the TBS.

2. The method of claim 1, wherein determining the TBS comprises:
determining a total number of available resource elements, REs, in the plurality of slots;
determining, based on the total number of available REs, the number of allowed information bits in the plurality of slots; and
determining the TBS based on the number of allowed information bits.

3. The method of claim 2, wherein determining the total number of available REs in the plurality of slots comprises:
determining the number of available REs for each slot of the plurality of slots; and
determining the total number of available REs as a sum of a plurality of numbers of available REs determined for the plurality of slots.

4. The method of claim 2, wherein determining the total number of available REs on the plurality of slots comprises:
determining a reference number of available REs for a reference slot of the plurality of slots; and
determining the total number of available REs as a product of the reference number of available REs and the number of slots of the plurality of slots.

5. The method of claim 1, wherein transmitting the TB comprises:
generating a plurality of coded bits from the TB;
grouping the plurality of coded bits into a plurality of TB trunks; and
mapping the plurality of TB trunks onto a plurality of physical resource blocks, PRBs, over the plurality of slots on the basis of PRBs or on the basis of slots.

6. The method of claim 1, wherein transmitting the TB comprises:
generating a plurality of cyclic redundancy check bits from the TB;
generating a plurality of coded bits from the TB based on the plurality of cyclic redundancy check bits;
dividing the plurality of coded bits into a plurality of segments of coded bits; and
transmitting a segment of coded bits of the plurality of segments of coded bits in a slot of the plurality of slots.

7. The method of claim 1, wherein transmitting the TB comprises:
transmitting, over the plurality of slots, the TB using a redundancy version to enable the transmitted TB to be individually decoded.

8. The method of claim 7, further comprising:
retransmitting the TB over the plurality of slots using a different redundancy version to enable the retransmitted TB to be decoded.

9. The method of claim 1, wherein transmitting the TB comprises:
determining a code block, CB, size;
dividing the TB into a plurality of CBs with the CB size; and
transmitting the plurality of CBs over the plurality of slots.

10. The method of claim 9, wherein the CB size is:
a fixed value,
configured by a network device, or
selected from a set of CB sizes based on at least one of the TBS, the number of slots of the plurality of slots and coding rate.

11. The method of claim 9, wherein transmitting the plurality of CBs over the plurality of slots comprises:
determining the number of CB groups, CBG;
grouping, based on the number of CBG, the plurality of CBs into a plurality of CBG; and
transmitting the plurality of CBG over the plurality of slots.

12. The method of claim 11, wherein determining the number of CBG comprises:
determining a reference number CBG;
determining the number of CBG for the TB as a smaller number of the reference number of CBG and the number of CBs for the TB.

13. The method of claim 12, wherein the reference number CBG is indicated by a network device or the same as the number of slots of the plurality of slots.

14. The method of claim 11, further comprising:
receiving, from a network device, an indication of the number of CBG and the number of slots for retransmission of the TB.

15. The method of claim 1, wherein transmitting the TB comprises:
transmitting the TB in each of the plurality of slots using a different redundancy version.

16. The method of claim 15, wherein determining the TBS comprises:
for at least a slot of the plurality of slots,
modifying the number of allocated physical resource blocks, PRBs, based on the number of slots of the plurality of slots;
determining the number of available resource elements, REs, based on the modified number of allocated PRBs; and
determining a total number of available REs in the plurality of slots;
determining, based on the total number of available REs, the number of allowed information bits in the plurality of slots; and
determining the TBS based on the number of allowed information bits.

17. The method of claim 16, wherein determining the number of allowed information bits in the plurality of slots comprises:
modifying a coding rate for the TB based on the number of slots; and
determining, based on the total number of available REs and the modified coding rate, the number of allowed information bits in the plurality of slots.

18. A user device, comprising:
at least one processor; and
at least one memory including computer program code;
the at least one memory and the computer program code configured to, with the at least one processor, cause the user device to:
determine, at a user device, a transport block size, TBS, based on a plurality of slots; and
transmit, over the plurality of slots, a transport block, TB, with the TBS.

19. The user device of claim 18, wherein the at least one memory and the computer program code configured to, with the at least one processor, further cause the user device to:
determine a total number of available resource elements, REs, in the plurality of slots;
determine, based on the total number of available REs, the number of allowed information bits in the plurality of slots; and
determine the TBS based on the number of allowed information bits.

20. The user device of claim 19, wherein the at least one memory and the computer program code configured to, with the at least one processor, further cause the user device to:
determine the number of available REs for each slot of the plurality of slots; and
determine the total number of available REs as a sum of a plurality of numbers of available REs determined for the plurality of slots.

21-37. (canceled)
